(19) United States
(12) Patent Application Publication
(10) Pub. No.: US 2014/0062686 A1
(43) Pub. Date: Mar. 6, 2014

(54) PORTABLE VEHICLE SECURITY DEVICE, SYSTEM AND METHOD PROVIDING REMOTE VEHICLE MONITORING

(71) Applicant: MICHAEL FLORIO, DAVIE, FL (US)

(72) Inventor: MICHAEL FLORIO, DAVIE, FL (US)

(21) Appl. No.: 14/018,996

(22) Filed: Sep. 5, 2013

Related U.S. Application Data
(60) Provisional application No. 61/696,832, filed on Sep. 5, 2012.

(51) Int. Cl. B60R 25/102

(52) U.S. Cl. CPC B60R 25/102
USPC 340/426.18

(57) ABSTRACT

A vehicle security system is provided. A compact security device is portable between vehicles and connectable to a 12V DC vehicle power supply for charging an internal power source. The security device communicates with an electronic device of the user to provide information about the vehicle status to the user upon detection of a triggering event.

### CROSS-REFERENCE TO RELATED APPLICATIONS

The present application claims priority to: co-pending Provisional Patent Application No. 61/696,832, filed on Sep. 5, 2012, entitled “PORTABLE VEHICLE SECURITY SYSTEM WITH REMOTE ACTIVATION AND MONITORING”; that application being incorporated herein, by reference, in its entirety.

### BACKGROUND OF THE INVENTION

1. Field of the Invention

The present invention relates to vehicle security systems and, more particularly, to a portable security system for a vehicle that can be activated, deactivated and/or monitored remotely on a cell phone, tablet, computer or other electronic device.

2. Description of the Related Art

Vehicle alarm systems have been widely used for many years to prevent theft of vehicles and their contents. Typical vehicle alarm systems emit a loud sound, such as a siren or the vehicle's horn, and sometimes flash some of the vehicle's lights when the alarm system is triggered. The intent of the audible alarm system is to scare away the thief when the alarm is activated by drawing attention to the vehicle.

The problem with audible alarm systems today is that they are too sensitive and are, therefore, regularly triggered accidently by loud low frequency sounds, such as loud music, other cars and motorcycles with loud exhaust systems and thunderstorms, or when bumped into by people and other cars. Because the alarms are more often than not triggered accidently, most people, including police officers, ignore them when they are triggered. As a result, audible alarm systems in use today do not adequately serve the purpose for which they are intended.

Many vehicle alarm systems today can be activated and deactivated using the vehicle's key fob or a separate fob. This allows users to activate the alarm as they depart the vehicle and deactivate the alarm prior to re-entering the vehicle by pressing buttons on the fob. However, users must be within close proximity to the vehicle, usually within view of the vehicle, in order to activate or deactivate the alarm.

Additionally, unless the user is in close proximity to the vehicle, the user will not hear the alarm if it is triggered. Therefore, if the vehicle alarm is triggered while the user is outside the audible range, the user will not be aware that the alarm has been triggered and the vehicle and/or its contents are susceptible to being stolen or, if the alarm was accidently triggered, the alarm will continue to sound until the system shuts it off or the vehicle battery dies.

U.S. Patent Application Publication No. 2012/0100828 to Leblanc (“Leblanc”) discloses an alarm notification system and method wherein a mobile phone is installed with an apparatus. including one or more modules configured to detect a change in the mobile phone's power mode, and upon the detection of the change, to notify a user. Leblanc, which is incorporated herein by reference, requires a mobile phone to be attached to the apparatus so as to detect a condition of the mobile phone to determine an alert condition. What is needed is an alarm notification system that does not need a mobile phone to be connected to the device. What is further needed is an alarm notification system that detects an external condition of the vehicle, and not of an attached mobile phone.

Accordingly, there is a need in the art for a new and improved vehicle security system that can be activated, monitored and controlled remotely. Any such system should be capable of use with a cell phone, tablet, computer or other electronic device. Such system should be further capable of sensing an event external to the security device, such as glass breakage, opening of doors, tilting, impact and/or motion. Any such system should be further capable of alerting the user on his or her cell phone, tablet, computer or other electronic device when the alarm is triggered. In addition, there is a need for a system that allows the user to view video of the vehicle on the user's cell phone, tablet, computer or other electronic device so that the user can assess whether there is a valid threat to the vehicle and/or its contents or whether the alarm was accidently triggered. Such system should be further capable of allowing the user to reset the alarm from his or her cell phone, tablet, computer or other electronic communication device if the user determines that the alarm was triggered accidently. There is a further need for such a system that is portable so that it can be transported and used in different vehicles without requiring a mechanic to do so.

### SUMMARY OF THE INVENTION

The present invention relates to a vehicle security system that overcomes the disadvantages of the prior art. More particularly, a compact security device transportable between vehicles is provided. The device is connectable to a 12V DC vehicle power supply for charging an internal power source. The security device communicates with an electronic device of the user to provide information about the vehicle status to the user. In one particular embodiment, the security device can be activated, monitored and controlled remotely from a cell phone, tablet, computer or other electronic device, via a software application (“app”) downloadable to the electronic device. In one particularly preferred embodiment, the security device is encapsulated in a compact, plug-in connector configured to mate with a vehicle power receptacle (e.g. a cigarette lighter power outlet) to draw 12V DC electrical power from the vehicle battery to charge an internal power supply when the vehicle is operating. In an alternate embodiment, the device includes a connector for connecting to the vehicles 12V DC power supply for vehicles without power receptacles (i.e., motorcycles, scooters, a Segway, etc.). Additionally, the device includes one or more sensors to detect a vehicle related condition external to the security device, such as, but not limited to, glass breakage, door openings, tilting, impact and/or motion and a communication circuit for reporting information about that condition to an electronic device of the user

Other features, which are considered as characteristic for the invention, are set forth in the drawings and the appended claims.

Although the invention is illustrated and described herein as embodied in a portable vehicle security system with remote monitoring, it is nevertheless not intended to be limited to the details shown, since various modifications and structural changes may be made therein without departing from the spirit of the invention and within the scope and range of equivalents of the claims.

The construction of the invention, together with additional objects and advantages thereof, will be best understood from the following description of the specific embodiment when read in connection with the accompanying drawings.

### BRIEF DESCRIPTION OF THE SEVERAL VIEWS OF THE DRAWINGS

For a fuller understanding of the nature of the present invention reference should be made to the following detailed description taken in connection with the accompanying drawings in which like reference numbers represent like elements, wherein:

FIG. 1 is a simplified view of a vehicle security system in accordance with one particular embodiment of the present invention.

FIG. 2A is one particular embodiment of a security device for use in a vehicle security system in accordance with the present invention.

FIG. 2B is another particular embodiment of a security device for use in a vehicle security system in accordance with the present invention

FIG. 3 is a simplified block diagram illustrating a circuit for a security device in accordance with one particular embodiment of the present invention.

FIG. 4 is a simplified illustration of a user device displaying information received from a security device in accordance with one particular embodiment of the invention.

FIG. 5 is a flow diagram for a method of operation of a vehicle security system in accordance with one particular embodiment of the present invention.

### DETAILED DESCRIPTION OF THE PREFERRED EMBODIMENT

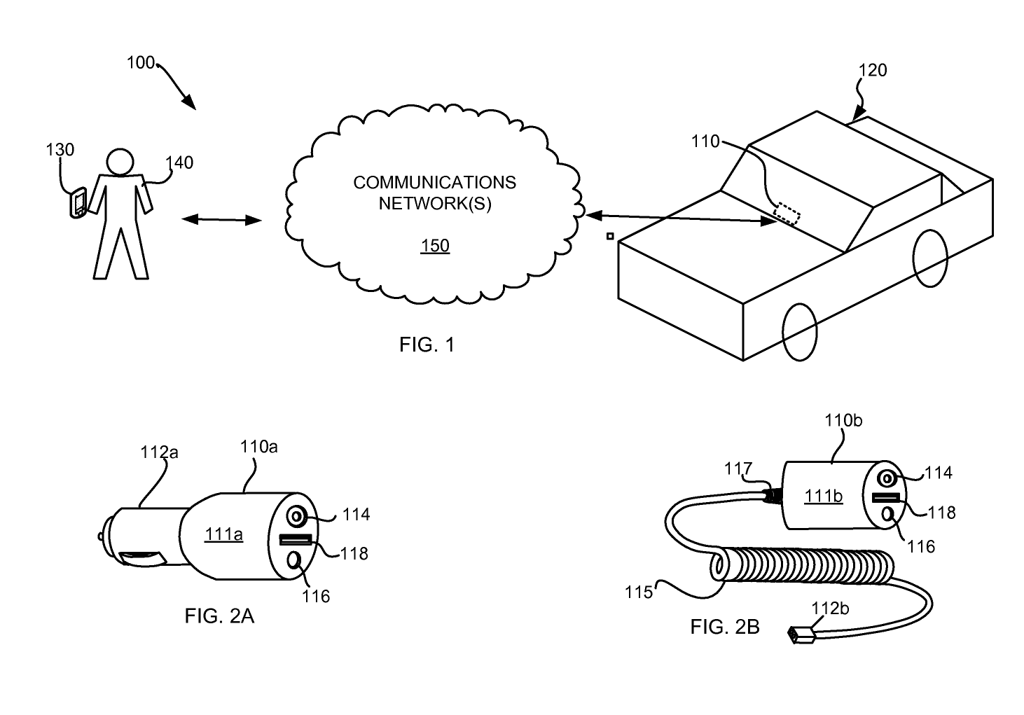

Referring now to FIGS. 1-4, the present invention is directed towards a vehicle security system 100 in which a security device 110 disposed in a vehicle 120 communicates vehicle information with an electronic device 130 of a user 140, via a communications network 150. The communications network 150 can be selected to best fit the electronic device 130, with which the device 110 communicates. Such communications networks include, but are not limited to, mobile telephone networks, GSM, GPRS and the Internet. Each device 110 and 130 includes, among other things, a modem that can communicate with one or more of the networks 150.

Security device 110 additionally includes a housing 111, which encloses a circuit board and various circuit elements making up the security device 110. In one particularly preferred embodiment shown in FIG. 2A, a security device 110a includes a housing 111a shaped to fit into a vehicle charging receptacle or cigarette lighter receptacle. More particularly, the security device 110A includes a plug-in connector portion 112a, including contacts that interact with contacts of the charging receptacle, to provide 12V DC from the vehicle battery to the circuitry of the security device 110a. Security device 110a is sized to be compact, lightweight, completely portable and unobtrusive (i.e., avoiding notice). No retrofitting of the vehicle or complicated and permanent installation is required. The security device 110a simply plugs into an existing receptacle of the vehicle and can be used (i.e., plug-and-play). A charging circuit 270 is configured to charge an energy storage device 260 and/or provide a charging voltage to a device plugged into a port 118 when the plug-in connector portion 112a is inserted into the vehicle cigarette lighter/power receptacle.

In another embodiment of the invention shown in FIG. 2B, a security device 110b is provided for use in vehicles that do not have a plug-in charging receptacle, such as a motorcycle, scooter, Segway or other vehicle having a 12V DC output. Instead of a plug-in portion sized to mate with a plug-in charging receptacle or cigarette lighter receptacle, the security device 110b is provided with a power cord 115 connected between the housing 111b and a connector or adapter 112b. The connector 112b is adapted to connect to a mating connector or wiring harness existing on the vehicle, or which can be readily added without a complicated service procedure. Alternately, a connector for mating with the connector 112b can be attached across the battery terminals with alligator clips or some other mechanism, or the connector 112b can be replaced by clips for connecting to the battery terminals directly, if desired.

The connector 112b allows the security device 110b to be easily attached and detached, and the size and form of the housing 111b permit the device 110b to be portable for use in other vehicles. Although shown as cylindrical in shape, it should be understood that the security device 110a and 110b can be made in other shapes and having other forms, without departing from the scope of the present invention, so long as the device 110 remains portable.

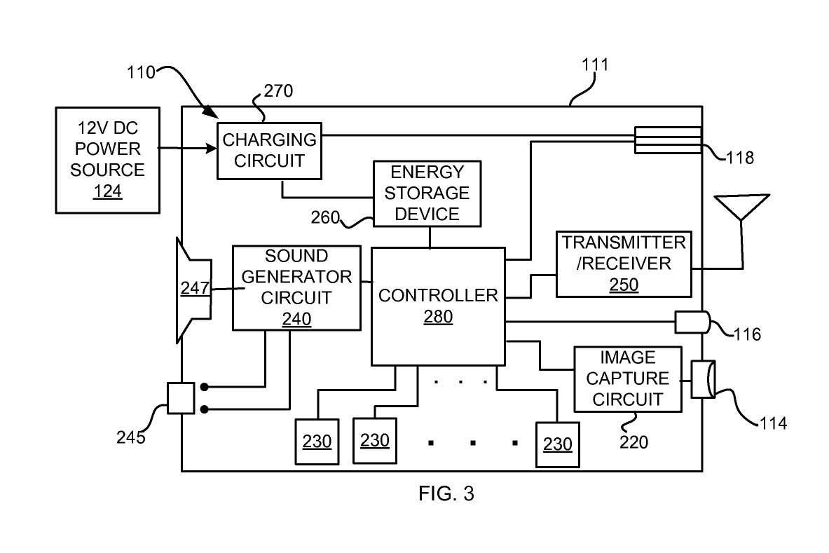

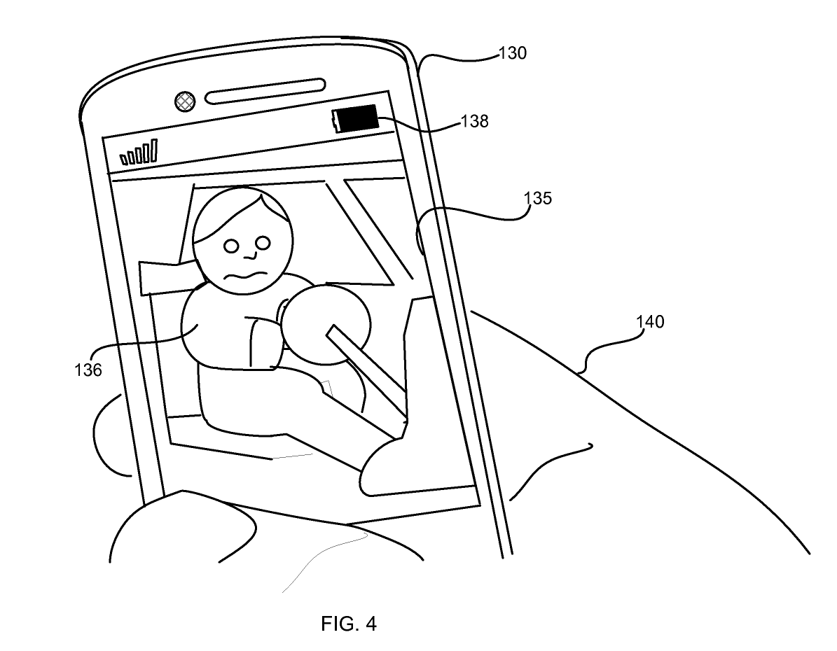

Referring back to FIGS. 1-4, and more particularly, to FIG. 3, the security device 110, 110a, 110b includes, among other things, one or more sensors 230, a sound generator 240, a transmitter/receiver device 250, an energy storage device 260 (e.g., a rechargeable battery or storage capacitor), a charging circuit 270 and controller 280. Controller 280 may be any type of controller desired, such as a microprocessor configured by software stored in a memory, a microcontroller, a PLA, hardwired circuitry, etc.

As discussed above, the vehicle security device 110 includes a connector to receive a 12V DC electrical power input from a 12V DC power source 124, such as the vehicle battery. The connector can take the form of a plug-in connector 112a integral with the housing 111a and adapted to mate with a plug-in vehicle receptacle, or a cable 115 and connector combo 112b attached to the housing 111b. When engaged, the connector provides the 12V DC input to the charging circuit 270, which, in turn, charges the energy storage device 260, to ensure the proper operation of the security device 110 when the vehicle is off or power is otherwise not being supplied from the 12V DC power source. In one particular embodiment of the invention, the energy storage device 260 is a conventional, rechargeable battery that is electrically connected to the charging circuit 270. In the present preferred embodiment, the battery 260 is a AA or AAA battery that can be replaced when it has reached the end of its useful life. This is not meant to be limiting, however, as other types and voltages of batteries and/or other types of energy storage devices (such as a storage capacitor) can be used as the energy storage device 260 without departing from the spirit of the present invention.

In one particular embodiment of the invention, a security device 110a of FIG. 2A additionally includes a locking mechanism in the connector portion 112a to prevent removal from the vehicle cigarette lighter port when the alarm is triggered, so that the device 110a cannot simply be thrown from the vehicle as the audible alarm is sounding. For example, in one particular embodiment, an electromagnetic mechanism is engaged to secure the device 110a in the plug-in vehicle power receptacle. However, it should be appreciated that the connector 112a may be secured within the charging receptacle by any other means now known or later developed.

Additionally, in one particular embodiment of the invention, the device 110a, 110b, additionally includes a port 118, such as a USB port, structured to mate with a cable for charging a mobile telephone or other electronic device. When a charging cable attached to a load device is plugged into the port 118, the charging circuit 270 additionally (or alternately) provides a charging voltage to an attached mobile telephone or other attached electronic device. Although port 118 is described as a USB port in the present embodiment, this is not meant to be limiting, as the port 118 may be any type of interface port known or later developed for this purpose. Note however, that the present invention does not need a mobile phone to be connected to the device in order to determine a triggering event, in contrast to the Leblanc reference discussed in the Background, above. Rather, whether or not a mobile phone or other device is plugged into a port 118 is irrelevant to this determination. Rather, the present invention determines a triggering event by sensing a triggering condition of the vehicle, itself, and not of an attached load device or mobile phone. If desired, the device 110 can be configured to prevent charging of a load device connected to the port 118 from the energy storage device 260, in order to preserve the charge in the energy storage device 260 for powering the alarm portion of the security device 110.

The security device 110 of the present embodiment includes a controller 280 programmed to activate an alarm upon the determination of an alarm triggering event. The controller 280 (and certain other of the components of the device 110, which connections are not shown for simplicity) is powered by the energy storage device 260. In the present particular embodiment, the controller 280 is a solid state device programmed by software or firmware stored in an associated onboard memory, such as a microcontroller or microprocessor, although other forms of programmable or hardwired controllers may be used.

The controller 280 is configured or programmed to determine a triggering event from signals received from one or more trigger event sensors 230. Trigger event sensor(s) 230 is/are configured to detect a vehicle related condition external to the security device such as, but not limited to, one or more of glass breakage, door opening, tilting, impact and/or motion. It should be appreciated that any types and number of sensors now known or later developed that are capable of detecting sound, light, movement, energy or any other type of triggering event may be used within the spirit and scope of the present invention. The controller 280 measures the levels of signals received by the sensors 230 and initiates an alarm when one or more measured signals exceed a predetermined level. In one particular embodiment of the invention, only one measured signal in excess of the predetermined level is needed to initiate an alarm condition. In another particular embodiment of the invention, two or more signals in excess of a predetermined level are used to trigger an alarm signal.

Additionally, the controller 280 is responsible for initiating or triggering an alarm condition according to preprogrammed rules stored in a non-transitory memory device of the security device 110. Among other things, the controller 280 is responsible for initiating communication between the security device 110 and a particularly selected electronic device 130 of the user 140, in response to the determination of a triggering event. Absent an alarm condition, the controller 280 additionally communicates with the electronic device 130 to activate, deactivate and/or disregard an alarm, as instructed by the electronic device 130. Optionally, the controller 280 triggers the sound generator circuit 240 and speaker 247 to issue an audible alarm when a triggering event is determined. In devices 110 including a locking mechanism, the controller 280 additionally activates the locking mechanism to lock a device 110a into a plug-in vehicle receptacle either when the alarm is first activated or upon the detection of a triggering event, as desired.

In one particular embodiment of the invention, the controller 280 also controls a visual indicator 116, such as an LED or other indicator, visible from outside of the housing 111, that lights or blinks when the vehicle security system 100 is active.

As mentioned above, one particular embodiment of the invention includes a sound generator circuit 240 and speaker 247 are included in the device 110. The sound generator circuit 240 may include an amplifier to increase the decibel level of the audible sound. The sound generator circuit 240 can be used to provide an audible signal in response to an alarm triggering event. A self test button 245 may also be included to allow the user to test the sound generator circuit 240 and confirm that the audible alarm is properly functioning.

Additionally, the controller 280 controls a transmitter/receiver 250 configured to transmit and receive between the controller 280 and an electronic device 130 of the user 140 using radio frequency communications or a like type of communication. In one particular embodiment of the invention, the transmitter/receiver 250 is configured for communications over a mobile communications network. In another embodiment of the invention, transmitter/receiver 250 is configured to communicate with a remote electronic device 130 via a Wi-Fi hotspot. In a further embodiment of the invention, for local monitoring, the transmitter/receiver 250 can be linked to a device 130 using Bluetooth, or another type of communications system. The range within which signals may be transmitted and received will vary depending upon the capabilities of the transmitter/receiver 250 selected. Although the preferred embodiment discloses the use of a radio frequency transmitter/receiver 250, it should be appreciated that other transmitter/receiver technologies may be used within the spirit and scope of the present invention. In the present preferred embodiment of the invention, the transmitter/receiver 250 communicates packetized digital data to, and receives packetized digital data from, the electronic device 130.

Optionally, the device 110 can additionally include an image capture device or camera including image capture circuit 220 and a lens 114 extending through the housing 111. The camera can be used to capture still or video images within the field of view of the security device 110. The captured images can be processed by the image capture circuit 220 and/or the controller 280 and transmitted to the electronic device 130, via the transmitter/receiver 250. In one particular embodiment of the invention, the image capture circuit 220 is a CCD image sensor that provides raw image data to the controller 280, which includes software for processing, compressing and encoding the captured images and for transmitting them to the electronic device 130. In another particular embodiment of the invention, video captured by image capture circuit 220 and lens 114 is streamed from the security device 110 to the electronic device 130 in response to a triggering event determination by the controller 280. If desired, video or still images can be sent or streamed from the security device 110 to the electronic device 130 in response to a request from the electronic device 130.

As described herein, the security device 110 is configured to transmit information to, and receive information from, an electronic device 130 of the user 140. This electronic device 130 can be any type of electronic device that can communicate with the security device 110 and process data received from that device 110. Possible electronic devices 110 include, but are not limited to, a mobile telephone, smartphone, PDA, electronic tablet device or ebook reader, laptop, computer or gaming appliance (such as a Nintendo 3DS having network communications abilities). The electronic device 130 is also, preferably, configured to download and store a software application executable by a processor of the electronic device 130. Alternately, the software application can be provided in firmware or the functionality can be implemented by hardware in the electronic device 130. In one particular embodiment of the invention, a software application 110 is downloaded onto a user's mobile telephone, tablet, computer or other electronic device 130 via the Internet, a cellular telephone network or by any other means for downloading such an application.

The software application executable on the electronic device 130 provides that device 130 with the instructions needed for communicating with the vehicle security device 110. Among other things, the software application permits the electronic device to transmit signals to the vehicle security device 110 to activate and deactivate the vehicle security system 100 and to receive signals from the vehicle security device 110 so that the user is alerted when an alarm has been triggered. The software application additionally also allows the electronic device 130 to display images 136 (video or still) captured by the camera of the security device 110 on a display 135 of the device 130 for viewing by the user 140. By viewing the images 136, the user will be able to determine whether the alarm was triggered accidently or whether there is a real threat to the vehicle 120 and/or its contents. Optionally, the software application can also display a battery level indicator 138 on the user's mobile telephone, tablet, computer or other electronic device 100 so that the user can monitor the remaining battery level of the vehicle security device 110.

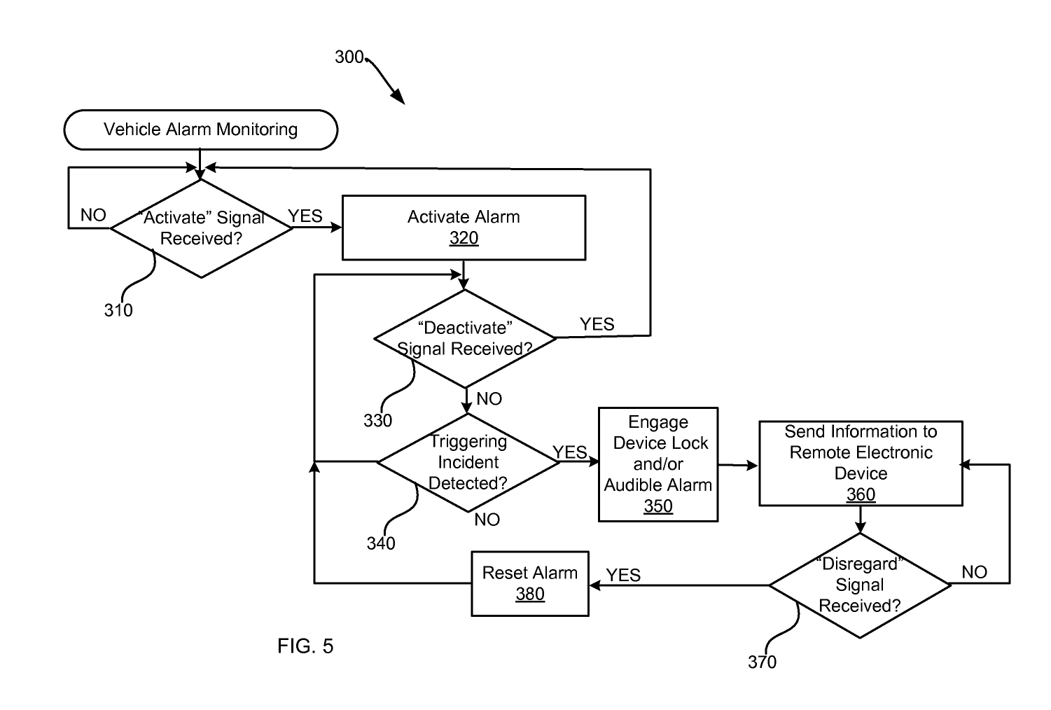

Referring now to FIGS. 1-5, there will be described a method 300 for providing vehicle alarm monitoring in a vehicle security system 100 in accordance with one particular embodiment of the present invention. The system is initiated by first downloading and/or executing an application on the electronic device 130 of the user 140. As discussed above, such an application can be obtained over the Internet and/or via a mobile radio communications network, or even transferred from computer media to the electronic device 130 using a computer. Alternately, the application can be resident on the electronic device when the electronic device 130 is received by the user 140.

The security device 110 is then mated with the 12V DC source of the vehicle, either by plugging the body connector 112a of a device of the type of 110a of FIG. 2a into a vehicle charging/cigarette lighter receptacle, or by mating it with the power source via a connector 112b or some other connector for a device of the type 110b of FIG. 2b.

Additionally, the application executed by the electronic device 130 includes software instructions that, among other things, permit the security device 110 to be mated with the electronic device 130. Such mating can be performed by exchanging web addresses, by storing a telephone number of the device 130 in the security device 110, by linking the devices by Bluetooth, or any other desired method of linking two devices for communication.

Once connected and mated with the device 130, monitoring by the security device 110 can be activated by a signal sent from the electronic device 130. Steps 310 and 320. Alternately, the security device can include a push button (not shown) which will permit manual activation of the security device.

Once activated, the device 110 will monitor the sensors 230 for a triggering event until the device 110 is deactivated by an instruction received from the electronic device 130. Steps 330 and 340. When the vehicle security device 110 determines the occurrence of a triggering incident external to the security device, such as glass breakage, opening of doors, tilting and/or motion, an alarm state is initiated. Step 340. Once initiated, the controller 280 engages the locking mechanism on the device 110 (if it has such a locking mechanism). Step 350. Alternately, if desired, in a device having an engageable locking mechanism, such a locking mechanism can be engaged by the controller at the time that the vehicle alarm is activated (i.e., at step 320). Additionally, if desired, an audible alarm is triggered at this time. The controller 280 then transmits information of the alarm condition to the electronic device 130 previously mated with the security device 110. Step 360. In one particular embodiment of the invention, the information is in the form of data packets including information used by the software application to alert the user to the occurrence of the alarm condition. Upon receipt, a processor of the electronic device will process the information according to rules provided by the application executing on the electronic device 130. In one particular embodiment of the invention, the software application will cause the user's electronic device 130 to alert the user 140 by producing a vibration, audible sound and/or visible message or indicator. The user 140 may then view images 136 captured by the camera of the security device 110 and transmitted to the user's electronic device 130 to determine whether the alarm was triggered accidently or whether there is a real threat to the vehicle or its contents. If the user determines that the alarm was triggered accidently, the user can then send a signal to the security device 110 to disregard and reset the alarm. Steps 370 and 380. The device 110 will continue to send information to the electronic device 130 until the alarm condition is reset or the electronic storage device 260 is discharged.

As can be seen, the vehicle security device 110 of the present invention is compact, lightweight, self-contained and portable so that it can be used in different vehicles without the need for retrofitting or expensive service. The user can simply remove connector 112a, 112b, from a vehicle power receptacle or connector and transport the system to another vehicle where it can then be connected to power in that vehicle in the same way.

While a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A security device for a vehicle, comprising:
a compact housing containing:
a controller;
at least one sensor selected to provide an output representative of a vehicle related triggering event, said at least one sensor connected to said controller;
and a transmitter/receiver configured to communicate wirelessly with a remote electronic device upon a determination of a triggering event being made by said controller based on the output of said at least one sensor;
said compact housing including a connector for removably connecting the device with a power source of the vehicle to provide power to the security device.

2. The security device of claim 1, wherein the connector is a plug-in connector integral with said housing and configured for mating with a vehicle charging/cigarette lighter receptacle of the vehicle.

3. The security device of claim 2, wherein the connector includes a locking mechanism for locking said plug-in connector into the vehicle charging/cigarette lighter receptacle of the vehicle.

4. The security device of claim 3, wherein the locking mechanism includes an electromagnetic mechanism.

5. The security device of claim 3, wherein the locking mechanism is engaged upon detection of a triggering event.

6. The security device of claim 1, wherein the housing additionally contains a charging circuit connected to an energy storage device, said energy storage device powering said controller.

7. The security device of claim 1, additionally including a port for connection with an external device, said charging circuit additionally connected to said port.

8. The security device of claim 1, wherein said housing additionally contains an image capture device, said controller processing images captured by said image capture device and providing them to the transmitter/receiver upon a determination of a triggering event.

9. The security device of claim 1, wherein said housing additionally includes a sound generator for producing an audible alarm upon a determination of a triggering event.

10. A vehicle security system including:
a device according to claim 1;

11. The vehicle security system of claim 10, wherein said device communicates with a remote electronic device via a communications network.

12. The vehicle security system of claim 11, wherein the said device provides an indication of a triggering event to said remote electronic device via the communications network.

13. The vehicle security system of claim 12, wherein said device provides image data to said remote electronic device for display on a display of said remote electronic device.

14. The vehicle security system of claim 12, wherein said remote electronic device is configured to at least one of remotely activate and remotely deactivate an alarm monitoring state of said device.

15. A method for monitoring a vehicle, comprising the steps of:
providing a security device including:
a compact housing containing:
a controller;
at least one sensor selected to provide an output representative of a triggering event, the at least one sensor connected to the controller;
and a transmitter/receiver configured to communicate wirelessly with a remote electronic device upon a determination of a triggering event being made by the controller based on the output of the at least one sensor;
the compact housing including a connector for removably connecting the device with a power source of the vehicle to provide power to the security device;
mating the security device with an electronic device configured to at least one of remotely activate and remotely deactivate an alarm state of the security device.

16. The method of claim 15, further including the step of transmitting information of an alarm condition from the security device to the remote electronic device upon a determination by the controller of a triggering event.

17. The method of claim 16, further including the step of transmitting images from the security device to the remote electronic device upon a determination by the controller of a triggering event.

18. The method of claim 15, wherein the connector is a plug-in connector integral with the housing and configured for mating with a vehicle charging/cigarette lighter receptacle of the vehicle.

19. The method of claim 18, wherein the method further includes the step of engaging a locking mechanism to lock the plug-in connector into the vehicle charging/cigarette lighter receptacle of the vehicle.

20. The method of claim 19, wherein the locking mechanism includes an electromagnetic mechanism.
